(19) United States
(12) Patent Application Publication
(10) Pub. No.: US 2015/0310060 A1
(43) Pub. Date: Oct. 29, 2015

(54) Memtag(s), Automated Creation of a Timeline Archive For Improving Personal, Business and Government Productivity and Communications

(71) Applicant: Lawrence F. Glaser, Fairfax Stn., VA (US)

(72) Inventor: Lawrence F. Glaser, Fairfax Stn., VA (US)

(21) Appl. No.: 14/693,041

(22) Filed: Apr. 22, 2015

Related U.S. Application Data
(60) Provisional application No. 61/983,282, filed on Apr. 23, 2014.

(51) Int. Cl. G06F 17/30

(52) U.S. Cl. CPC G06F 17/30401; G06F 17/30876; G06F 17/30554

(57) ABSTRACT

The present invention defines the MEMTAG Archive, which provides a single point of review and archive for all information that relates to a unique user of electronic devices, to efficiently keep track of the user's important information and communications. The invention presents an important improvement to browser and browser history, email domain, word processing, spreadsheet programs, social nets and social net timelines and the like.

### TECHNICAL FIELD

The technical field applicable to this invention includes the fields of electronic devices, electronic systems, networks and microprocessor-based devices or input output devices used to access information.

### BACKGROUND

The field of modern communications using electronic devices to access networks, information and communications, continues to explode exponentially. We live in an age of RSS feeds, Tweets, Emails, Instant Messages, Chats, Photos, Videos, documents, information, digital objects and the like, providing no single point of review for the user. A user must remember where and when they have stored important information in order to access, modify, share or otherwise use the information. Information, in the context of this invention, includes any and all data objects including communications, images, videos, documents, any data set which could be considered an object.

### SUMMARY

Provision of a single point of review and archive for all information that relates to a unique user is thus an important improvement to introduce to the already common cadre of browser and browser history, email domain, word processing, spreadsheet programs, social nets and social net timelines and the like.

The MEMTAG Archive is defined herein and is provided to break this endless chain of complexity, allowing a user to automate the feed of their information, both inbound, outbound or predetermine, to a single point of review, so they can do more in less time with greater efficiency and no loss or misplacement of important information.

The MEMTAG archive allows for manual and automatic chronologic posting and storage of information for real time or delayed review by a given user or by a given group of users. Obviously, one user could have more than one MEMTAG account, or in the one account, post as different users (e.g. as avatars, aliases) even though the individual remains unique.

Exploring the operation of the archive assists in revealing its novelty and uniqueness.

US#20140074696 and US#20140183269 are herein incorporated by reference in their entirety.

### BRIEF DESCRIPTION OF DRAWINGS

FIG. 1 shows MEMTAG icon 100 of the present invention displayed on an electronic user device such as a tablet 101, with details.

FIG. 2 illustrates an archive for the MEMTAG of FIG. 1 and some graphic and textual views of the archive, including classification and content associations.

### DETAILED DESCRIPTION OF THE DRAWINGS

The present invention proposes a MEMTAG archive.

For purposes of this document and the appended claims, MEMTAG refers to a tag which is associated with a piece of information to provide a single point of review and archive, such as a timeline. In accordance with the present invention and as is described in detail below, a memtag presents a chronology to serve as a basis for a search, the search will be on that chronology not the whole WWW. A memtag offers a single click function for adding information to personal time line, which then forms a searchable data base.

In accordance with an ideal method of use of the present invention, a standard could be introduced to industry. However, utility of the present invention is not limited to creation of a new standard and even in the absence, software may be crafted which is capable of accurately copying an object to the MEMTAG archive. The software could recognize a unique object if ever presented once again to a user, to allow for a very simple icon to be added to the large complement of icons known to those of skill in the industry, with emphasis on software and graphic design of software control frames. This “MEMTAG” ICON needs to be distinct and distinctly placed, if possible. By way of example, an evergreen tree in deep forest green is proposed for this ICON. For every imaginable object a user may point to or cause to be their top-most tile in any given software or network environment, the ability to toggle this icon is present in the frame depicting or surrounding the given object. By way of example, when the tree is green, the object has not been stored. If you store the object, by selecting the green tree, the tree changes color and that change indicates the object is in your MEMTAG archive. Gold would be a good color choice. Possibly, we could allow freedom of color choices but it would be a prerequisite to have a standard, such as green and gold, to which a new user, accessing another user's MEMTAG archive, could toggle to the industry standard for ease of use and review. Users can have custom colors, but there will always be a requirement to have a toggle, so as to allow for industry standardized access and promote familiar usage.

Each unique user, having created a MEMTAG archive, may now copy information to their archive. Much of this, possibly all of this, can be accomplished in settings and made fully automatic. Although it may be preferable to store links in the archive, the whole data set found at the link is considered more desirable. In this manner, should the link or the data change or fail, the archive would still hold accurate information as of the time and date the user selected the object.

Each unique user may also log into their various networks and communications tools and software(s). In embodiments and in the context of the foregoing environments, a unique automation tool is provided to allow the user to customize settings and cause certain communications to auto-post to their MEMTAG archive. By way of example, any demographic of an email message may be used to form filters, so with the automation comes equally powerful filtration means to filter and feed only the messages desired from each possible message source. This could be the whole of an email mailbox, any and all communications in their order of receipt. Alternatively, this could be only the emails from friends and family, and then, only those who are linked in my social net account, such as linked in, twitter or facebook, to provide requisite examples. It should be instantly obvious to those of skill, this archive and the automation described, could be used to provide redundancy to other systems allowing for automated recovery of important information. Any and all communications, documents, photos, videos and other data objects may be auto fed to the MEMTAG archive and if so, when the user visits the original instance of the data in question, its ICON, the evergreen tree, will be gold already. Hence, when a data object is viewed and the evergreen tree icon is green, this invites the manual selection, permanently toggling the icon until such time as the user no longer wants this association and they may toggle the icon back to green, either within the archive or while looking at the original instance of the data object.

The foregoing suggests that objects, like a video, or a picture, can have a familiar icon, like a Christmas tree. You view the object and if you want to MEMTAG it, you click the tree. It changes color until you toggle back or never toggle back, and it would stay as is, as further explained herein.

Additionally, this invention, in an embodiment, focuses on the “properties” of the tree. If you hover over the tree, a pull down appears and “properties” is going to likely be at the bottom of the menu, since all other formatting for web pages and objects in general, tend to go that route. In the properties, you can see history of who memtaged the object, for example, you, or someone authorized to use your PC. For example, the tree or icon has a properties extension and in that extension one could learn the object was tagged, untagg-ed, tagged again by authorized user A, B and C, and the complete history of that string.

An ‘object’ as described above could be any and all objects one can display. It could be a song, MP3, video, picture, text, file, object, etc. Size of files matters, so we could limit the memtag to a certain size per object to prevent, for example, letting someone tag all of EBAY and its content which would halt processing and jam memory needlessly.

Colorization or other textural, or aural features of the invention allow for user settings to provide automatic or manual (toggle on, toggle off, apply like a style sheet, undo) colorization, textural or aural elements to any single element of the invention. While in the memtag archive, a useful feature could be to allow memtag content to be auto-imported to formats users are familiar with, such as into an XL spreadsheet, enabling the features of that program to perform other types of data manipulation, mining and archiving.

A MEMTAG archive, once established, may be rearranged logically, with fuzzy or soft logic or illogically, as a user desires. We will, however, keep features in the archive to assure the archive is never manipulated into a state which cannot be returned to “chronologic, show all” as a base state. Hence, there will likely always be a toggle within the MEMTAG archive to allow for viewing of a given day, hour or minute's MEMTAG archive entries, shown in chronologic order.

A MEMTAG archive, once established, may be searched exclusively and for “data mining” purposes, and the range of search can be limited by chronology or subject, as but two non-limiting examples. If a user was doing research on Julius Caesar, Emperor of Rome, for example, they could start by MEMTAG(GING) all they could find on the subject, to later data mine the MEMTAG archive, which may provide a more smooth and efficient search function. The reason for the improvement, aside from organization, is the idea that the archive could be formed in the cloud, with more powerful servers and more memory, and less contention, as well as less propagation delay during use. Because the system is fine tuned to allowing a unique user to access their data, the process and experience will be more smooth and have less contention. This is due to the environment being able to anticipate the purpose and use for the data itself. No extraneous links, data, contentions, propagation delays, switching, redirecting and the like, will ever be needed from within this archive. The data is there.

During the process of memtagging, per preferences, one can add key words to the object for later search results. The invention can provide suggested key words. So memtagging is still one click. But you can right click once tagged, and get more options. “key words” can have an auto and a manual. Auto generates a list of key words. manual, a blank slate with key word suggestions that one may drag and drop in or double click to include. The purpose of key word additions during memtagging is, when you go back to perform logical search functions on your memtagged items, you get better hits. We can limit our search to content, memtag keywords, or both. And we can use hard logic or soften the logic, in percentages. An example is to search for LARRY+GLASER+TIMSMITH+QUANTUM which would find any hits with all those specific words. Our search engine could have all the settings of any other search engine available including but not limited to google.

The MEMTAG concept is further enhanced by providing a MEMTAG tracker program which allows the user to see an instant access link or icon on their device, possibly at all times on the uppermost tile for quick access. Also, top tile display areas could be provided as MEMTAG tracker tools to allow for one or more fields of view to be established which always stay on top of the various open programs and communications and are able to be re-sized and reshaped. These fields of view provide the chronology stack of items one has memtagg-ed, either all items, or, multiple fields of view could be established for differing demographics of information the user is seeking to MEMTAG and then review later. For example, in researching Julius Caesar one could have a view-able area for specific references to Julius Caesar, another different field of view for other emperors of Rome and yet another for other important people of Rome who were never Emperors, such as Cicero. The sorting from the main chronologic stack to the side stacks could result in leaving the main stack unchanged. The sort could be manual or semi-automatic, and with artificial intelligence, based on word counts of key words, the sort could be fully automatic.

Soft logic would allow further settings to allow the same string to produce a broader range of hits. Yet further settings could allow the search engine to use hard logic on the words but soft on the combinations. Yet another setting could allow each search to be performed simultaneously by two or more different search engines but from only one search string entry, providing search results in different windows so the user can decide which engine is working best for the search quest in question.

The MEMTAG archive can be reorganized and a MEMTAG communication can be formed as a copy of a subset of the main archive, rearranged as the user desires, for communication to another receiving user or group of receiving users. In this instance, a link could be provided to the receiving user or group of receiving users so they may access the rearranged data in the actual MEMTAG archive, rather than to ship the content across a network or domain.

The MEMTAG concept is further enhanced by providing a MEMTAG tracker program which allows the user to see an instant access link or icon on their device, possibly at all times on the uppermost tile for quick access. Also, top tile display areas could be provided as MEMTAG tracker tools to allow for one or more fields of view to be established which always stay on top of the various open programs and communications and are able to be re-sized and reshaped. These fields of view provide the chronology stack of items one has memtagg-ed, either all items, or, multiple fields of view could be established for differing demographics of information the user is seeking to MEMTAG and then review later. For example, in researching Julius Caesar one could have a view-able area for specific references to Julius Caesar, another different field of view for other emperors of Rome and yet another for other important people of Rome who were never Emperors, such as Cicero. The sorting from the main chronologic stack to the side stacks could result in leaving the main stack unchanged. The sort could be manual or semi-automatic, and with artificial intelligence, based on word counts of key words, the sort could be fully automatic.

In order to defray the costs of this invention, the user may agree to terms of service which allows the owner of the invention to provide advertising to the user, in a manner the user finds to be useful and desirable. The invention may also be provided on a fee for access basis. Something emerging in other inventions of this inventor, allows users to enjoy the services of professional buyers, people who make their living providing direction to the users of memtag, for example. The direction they provide could be a recipe, such as, to make home made biscuits. In exchange for memtag being a free service, the users of memtag may receive these people's instructions to which the professional buyer is compensated by manufacturers and service providers, completing the link between memtag, the memtag user and payment for memtag services, which would feed in from manufacturers and service providers supporting the professional buyers who create the buying and recipe schemes for memtag users.

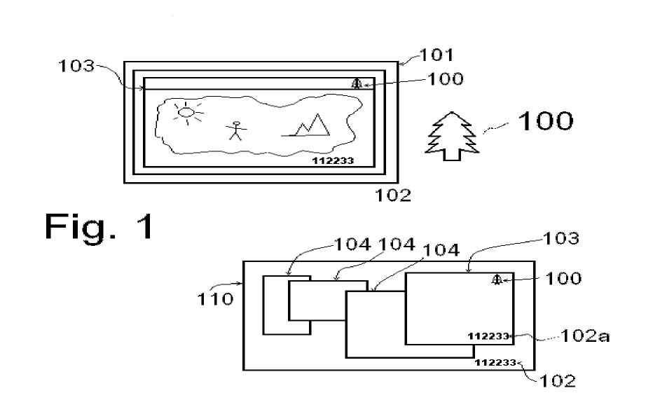

Referring to FIG. 1, a MEMTAG icon 100 is shown on a typical electronic user device such as a tablet 101. An uppermost tile 103 and lower tiles 104 are displayed, as well as the time & date contained in the user device associated with the moment the icon is selected 102. Also shown is the time date appearing in the object frame, 102a and another view within a tablet 110.

A unique user reviewing information 103, in this instance a photo, through their electronic device 101, may MEMTAG a unique object 103 through selection of the MEMTAG icon 100, causing a color or other viewable, aural, texture change in the icon or combinations of viewable, aural or textural. If the user leaves this view but returns to it later, the toggle of the MEMTAG 100 is remembered and the color and other attributes will reflect that the user selected or did not select the object for MEMTAG archiving. A time date stamp 102, will be applied to the event, passed to the MEMTAG archive. Within an alternative example and view 110, uppermost tile 103 contains its own time date data 102a, which will pass with the tile object to the MEMTAG archive.

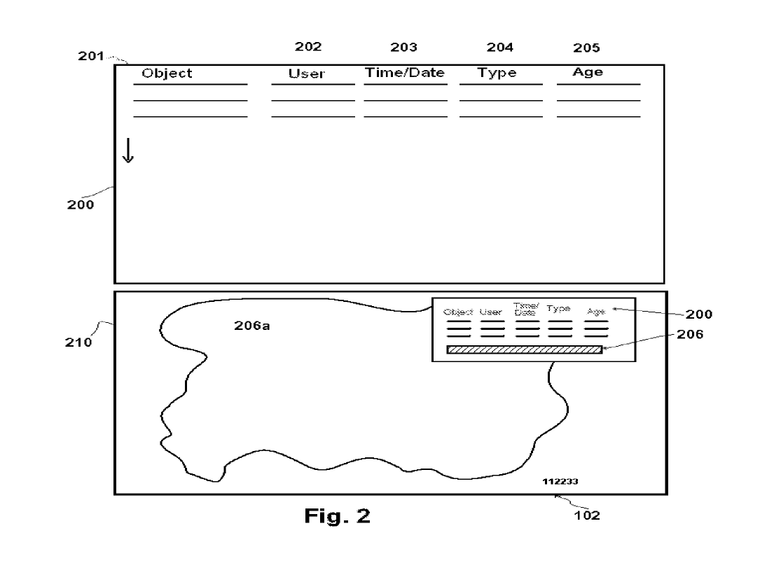

Referring to FIG. 2, the MEMTAG archive and some graphic and textual views of the archive 200 are shown. Inside the archive some classifications of information associated with object 201, include user 202, time date 203, object type 204, object age 205, selecting an object 206 and the content associated with the object 206a. A second example view is also shown as 210.

A searchable MEMTAG data base, (not shown) unique to the user, is addressed through a graphic and text screen 200. The objects are identified in the left most column 201, then the user 202, the time date 203, the object type 204 and the object age 205, looking from left to right across the screen 200. A second example view, 210, shows the first screen 200 view as a tile, where the content associated with object 206, content 206a, has been selected and the content associated with the object dominates the view 210, complete with time date 102.

Many modifications and other embodiments of the disclosure will come to mind to one skilled in the art to which this disclosure pertains having the benefit of the teachings presented in the foregoing descriptions and the associated drawings. Therefore, it is to be understood that the disclosure is not to be limited to the specific embodiments disclosed herein and that modifications and other embodiments are intended to be included within the scope of the appended claims. Although specific terms are employed herein, they are used in a generic and descriptive sense only and not for purposes of limitation.

I claim:

1. A method, in a computer system for assembling an information archive, of providing for chronologic posting and storage of information for real time or delayed review by a given account comprising;
associating a single point of review and archive, with a tag, for up to all information that relates to each said account; and
representing said tag by a unique object 103
displaying said archive
and wherein said account pertains to at least one user.

2. The method of claim 1 wherein said posting is accomplished manually.

3. The method of claim 1 wherein said at least one said associating with a unique object is automatically posted.

4. The method of claim 1 wherein said unique object 103 is an icon 100

5. The method of claim 4 further comprising causing a viewable, aural, textural, apparently textural, or color change in the icon.

6. The method of claim 4 wherein, If the user leaves off viewing but returns to it later,
the toggle state of the MEMTAG 100 is remembered and the color or other attributes will reflect that the user selected or did not select the object for MEMTAG archiving and further comprising applying a time and/or date stamp 102 to the event, to be passed to the MEMTAG archive.

7. The method of claim 6 wherein a screen tile 103 contains its own time date data 102a, which will pass with the tile object to the MEMTAG archive.

8. The method of claim 1 wherein said account comprises a single user or a single user alias ID.

9. The method of claim 1 wherein said account comprises a group of users or an alias which represents a specific virtual group ID.

10. The method of claim 1 wherein said archive content is hosted in an environment selected from the list of;
browser, browser history, web sites, urls, email domains, word processing, spread-sheet programs, social nets and social net timelines.

11. The method of claim 9 further comprising a searchable MEMTAG data base unique to the user which is addressed through a graphic and text screen 200 and wherein the objects are identified in a column 201 and further displaying of the user 202, the time date 203, the object type 204 and the object age 205 on the screen 200 and content associated with said object 206.

12. The method of claim 3 wherein automation tool can be provided to allow the user to customize settings and cause certain communications to auto-post to their MEMTAG archive.

13. The method of claim 3 wherein said step of automating comprises filtering

14. The method of claim 13 wherein said filtering comprises a demographic of an email message.

15. The method of claim 11 further comprising a history of who MEMTAG-ed the object.

16. The method of claim 11 further comprising toggling said icon in the frame depicting or surrounding the given object.

17. The method of claim 11 wherein said archive content is a link and up to the entire data set found at the is a link.

18. The method of claim 15 wherein the identity of said user is determined biometrically.

19. A computer system for assembling an information archive, of providing for chronologic posting and storage of information for real time or delayed review by a given account comprising;
a single point of review and archive, with a tag, for up to all information that relates to each said account; and
a representation of said tag by a unique object 103
a display of said archive
and wherein said account pertains to at least one user.

20. A computer system for assembling an information archive, of providing for chronologic posting and storage of information for real time or delayed review by a given account comprising;
a single point of review and archive, with a tag, for up to all information that relates to each said account; and
a representation of said tag by a unique object 103
a display of said archive
wherein said account pertains to at least one user and further comprising;
a searchable MEMTAG data base unique to the user which is addressed through a graphic and text screen 200 and wherein the objects are identified in a column 201 and further displaying of the user 202, the time date 203, the object type 204 and the object age 205 on the screen 200 and content associated with said object 206.
